(19) United States
(12) Patent Application Publication
(10) Pub. No.: US 2024/0281515 A1
(43) Pub. Date: Aug. 22, 2024

(54) CONTEXT INFORMATION MANAGEMENT SYSTEM AND METHOD FOR SPDM-ENABLED DEVICES

(71) Applicant: Dell Products, L.P., Round Rock, TX (US)

(72) Inventors: Mini Thottunkal Thankappan, Bangalore (IN); Shinose Abdul Rahiman, Bangalore (IN); Rama Rao Bisa, Bangalore (IN); Dharma Bhushan Ramaiah, Bangalore (IN); Vineeth Radhakrishnan, Palakkad (IN)

(73) Assignee: Dell Products, L.P., Round Rock, TX (US)

(21) Appl. No.: 18/171,893

(22) Filed: Feb. 21, 2023

(51) Int. Cl. G06F 21/44; G06F 21/57; G06F 21/64

(52) U.S. Cl. CPC G06F 21/44; G06F 21/575; G06F 21/64

(57) ABSTRACT

According to embodiments of the present disclosure, an Information Handling System (IHS) includes a Security Protocol and Data Model (SPDM)-enabled device, and executable instructions that may be executed to obtain a SPDM-based measurement of a license associated with the SPDM-enabled device, compare the measurement against a Reference Integrity Measurement (RIM) initially generated for the SPDM-enabled device, and when the measurement and the RIM do not match, generate an alert message indicating that the license is invalid.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

In modern day IHSs, administrative management is often provided via baseboard management controllers (BMCs). The baseboard management controller (BMC) generally includes a specialized microcontroller embedded on the motherboard of the IHS, and provides an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take some corrective actions, such as resetting or power cycling the system to get a hung O/S running again. These abilities save on the total cost of ownership of an IHS, particularly when implemented in large clusters, such as server farms.

### SUMMARY

According to embodiments of the present disclosure, an Information Handling System (IHS) includes a Security Protocol and Data Model (SPDM)-enabled device, and executable instructions that may be executed to obtain a SPDM-based measurement of a license associated with the SPDM-enabled device, compare the measurement against a Reference Integrity Measurement (RIM) initially generated for the SPDM-enabled device, and when the measurement and the RIM do not match, generate an alert message indicating that the license is invalid.

According to another embodiment, a Baseboard Management Controller (BMC) license file attestation method includes the steps of obtaining a Security Protocol and Data Model (SPDM)-based measurement of a license associated with the SPDM-enabled device conforming to a SPDM specification, and comparing the measurement against a Reference Integrity Measurement (RIM) initially generated for the SPDM-enabled device. When the measurement and the RIM do not match, the BMC license file attestation method further includes the step of generating an alert message indicating that the license is invalid.

According to yet another embodiment, a computer program product includes a computer readable storage medium having program instructions stored thereon that, when executed by an Information Handling System (IHS), cause the IHS to obtain a Security Protocol and Data Model (SPDM)-based measurement of a license associated with a SPDM-enabled device conforming to a SPDM specification, and compare the measurement against a Reference Integrity Measurement (RIM) initially generated for the SPDM-enabled device. When the measurement and the RIM do not match, the instructions generate an alert message indicating that the license is invalid.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS configured to implement embodiments described herein.

FIG. 2 illustrates an example BMC license file attestation system that may be used to ensure the integrity of BMC licenses according to one embodiment of the present disclosure.

FIG. 3 illustrates an example BMC license file attestation method showing how the BMC license file attestation system may access measurements of the license stored in the BMC to ensure that it is not tampered with according to one embodiment of the present disclosure.

FIG. 4 illustrates an example BMC license file attestation system that may be used to ensure the integrity of BMC licenses according to one embodiment of the present disclosure.

FIG. 5 illustrates an example BMC license file attestation method showing how the BMC license file attestation system of FIG. 4 may access measurements of the of the license stored in the BMC to ensure its integrity according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Cyber attackers are reportedly exploiting and abusing devices, such as platform interface protocol analyzers to steal unencrypted information, spy on network traffic and gather information to leverage in future attacks against platform components and component interfaces (e.g., I2C, PCIe, etc.) of an IHS. Detection of vulnerable platform components is not an easy task, and exploiting unpatched vulnerabilities could allow the attacker to take control of the IHS. Some example platform security risks may include compromised security in which hostile component insertion and compromised firmware updates can cause supply chain security issues. Another example platform security risk may include confidentiality and integrity risks in which data transfers that are unencrypted may be vulnerable to eavesdropping, stealing and tampering. Additionally, non-compliant security configuration errors, certificate management, platform security trust, and the like could lead to non-compliance with industry standard security policies. The DMTF SPDM specifications have been developed to alleviate such problems and reduce management overhead in maintaining and establishing the platform security within the IHS infrastructure domain.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard Specifications, such as the Intelligent Platform Management Interface (IPMI) and Systems Management Architecture of Server Hardware (SMASH) for computer system administration.

Baseboard management controllers (BMCs) are particularly well suited for the features provided by the Security Protocol and Data Model (SPDM) specification. The SPDM specification has been published by the Platform Management Components Intercommunication (PMCI) Working Group of the Distributed Management Task Force (DMTF). A particular goal of the SPDM specification is to facilitate secure communication among the devices of a platform management subsystem. Examples of a platform management subsystem may include an Information Handling System (IHS), such as a desktop computer, laptop computer, a cellular telephone, a server, and the like.

The SPDM specification defines messages and procedures for secure communication among hardware devices, which includes authentication of hardware devices and session key exchange protocols to provide secure communication among those hardware devices. Management Component Transport Protocol (MCTP) Peripheral Component Interconnect Express (PCIe) vendor defined message (VDM) channels, which supports peer-to-peer messaging (e.g., route by ID), allow a SPDM-enabled hardware device to issue commands to other SPDM-enabled hardware devices within a secure communication channel.

BMCs are typically provided from a vendor with various levels of licensing specifying different types of features that the BMC is allowed to perform. A license with more features cost more to the customers. For example, a data center license of a BMC can often be one of the most expensive licenses for a server (IHS). Nevertheless, firmware vulnerabilities are common as a hacker can potentially exploit vulnerabilities in the BMC, particularly when open source firmware (e.g., openBMC) can exploit and/or manipulate the license file and use the compromised license file to illicitly use high-end features of the BMC, thus causing a revenue loss to the vendor of the server. For example, an illicit user can exploit/manipulate a trial version of BMC firmware license to illicitly use unlicensed features of the BMC. As possibilities of firmware vulnerabilities exist, a defense in depth mechanism to protect the BMC license on some, most, or all severs provided by their vendor may be beneficial both in terms of, among other things, revenue security as well as consistent reliable management of the servers placed in service in the field. Accordingly, embodiments of the present disclosure provide a system and method for BMC license file attestation that ensures the integrity of BMC licenses throughout the serviceable life of its associated server.

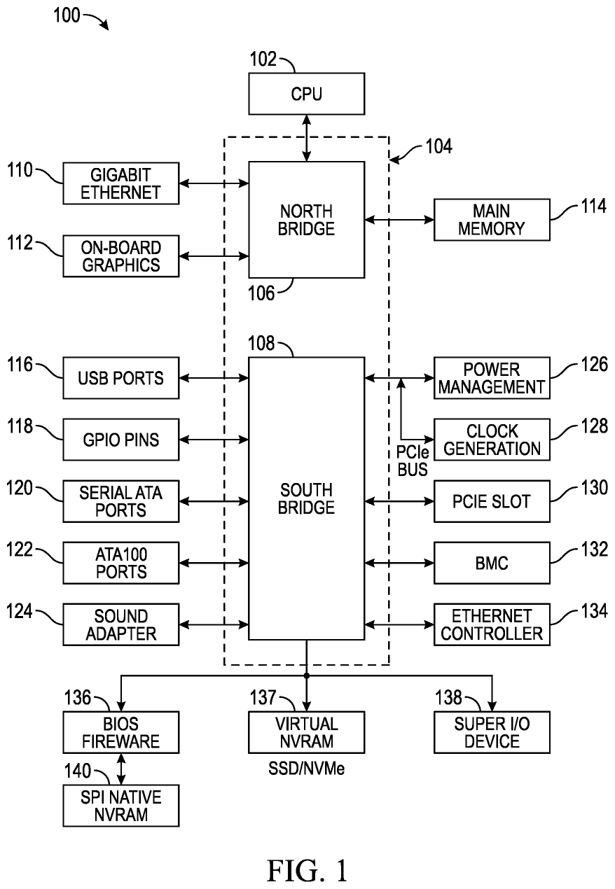

FIG. 1 shows an example of an IHS 100 configured to implement embodiments described herein. It should be appreciated that although certain embodiments described herein may be discussed in the context of a desktop or server computer, other embodiments may be utilized with virtually any type of IHS 100. Particularly, the HIS 100 includes a baseboard or motherboard, which is a printed circuit board (PCB) to which components or devices are mounted to by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in an embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The HIS 100 may also include a SPI native NVRAM 140 coupled to the BIOS/firmware 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

According to embodiments of the present disclosure, the IHS 100 may support SPDM in which the BMC 132 manages the operation of one or more managed devices configured in the IHS 100. Managed devices may include any SPDM-enabled device, such as on-board graphics adapter 112, Ethernet adapter 110, USB ports 116, sound adapter 124, Ethernet controller 134, GPIO pins 118, PCIe slot 130, Power management circuitry 126, clock generation circuitry 128, serial ATA ports 120, ATA100 ports 122, virtual NVRAM 137, SPI native NVRAM 140, and Super I/O device 138 as described herein above. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM spec also provides a slot mask that identifies each certificate chain.

According to embodiments of the present disclosure, the IHS 100 may support SPDM in which the BMC 132 manages the operation of one or more managed devices configured in the IHS 100. Managed devices may include any SPDM-enabled device, such as on-board graphics adapter 112, Ethernet adapter 110, USB ports 116, sound adapter 124, Ethernet controller 134, GPIO pins 118, PCIe slot 130, Power management circuitry 126, clock generation circuitry 128, serial ATA ports 120, ATA100 ports 122, virtual NVRAM 137, SPI native NVRAM 140, and Super I/O device 138 as described herein above. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM spec also provides a slot mask that identifies each certificate chain.

BMCs are typically sold with a license indicating a level of features that are to be granted to the end user (e.g., administrator) during use of an IHS (e.g., server). For example, a low-cost license may be issued to a BMC with only a subset of the features provided by a high-end license. Many currently provided BMCs may be configured with numerous features, such as an access to load and use an open source (e.g., openBMC) custom firmware, a right to access certain portions of bios (e.g., hardware inventory of the IHS 100), access to one or more thermal and/or power management algorithms provided by the BMC just to name a few. Nevertheless, for various reasons, such as ongoing firmware updates to the BMC, other components in the IHS 100, or the IHS 100 itself, vulnerabilities to the security of the licensed firmware of the BMC remains an ongoing concern. The inventors of the present invention have recognized that the features of the SPDM specification can be leveraged to ensure the integrity of the license used with BMC firmware as will be described here in detail herein below.

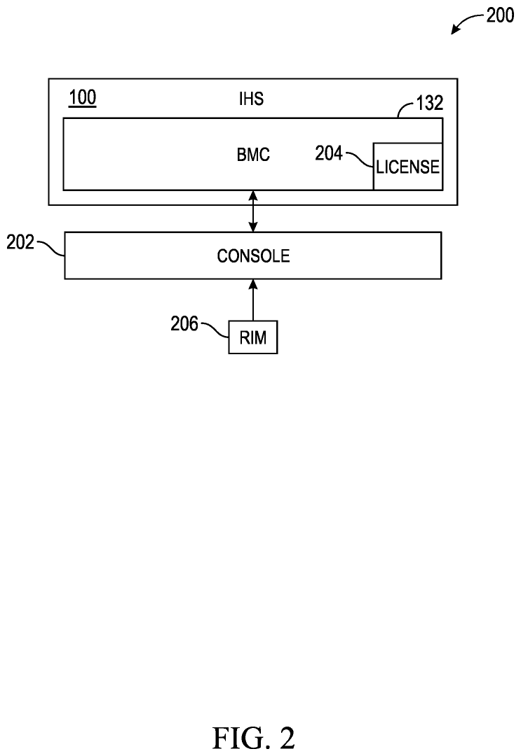

FIG. 2 illustrates an example BMC license file attestation system 200 that may be used to ensure the integrity of BMC licenses according to one embodiment of the present disclosure. The BMC license file attestation system 200 generally includes an IHS 100 configured with a BMC 132 in communication with a console 202. As will be described in detail herein below, the console 202 may query, using SPDM messaging, the BMC 132 at any suitable time to obtain measurements (e.g., PKI certificates) of a license 204 associated with the BMC 132, and compare the measurements against a Reference Integrity Measurement (RIM) 206 to ensure that the license has not been tampered with.

The RIM 206 generally includes a reference certificate that is generated based upon the license 204 granted to the end user, typically at the time that the user takes delivery of the IHS 100 configured with the BMC 132. For example, before shipping the IHS 100 to the user, the vendor, value added reseller (VAR), or other intermediary supplier may generate a license indicating to the BMC 132, what features are to be provided by the BMC 132, store the license 204 in a secure memory location on the BMC 132, generate the RIM 206, and store the RIM 206 for future reference. In one embodiment, the RIM 206 may be stored in an online support portal of the vendor, VAR, or intermediary supplier so that it may be provided to the console 202 over a publicly available network, such as the Internet.

According to embodiments of the present disclosure, the console 202 may utilize SPDM messaging to obtain measurements of the license 204 in which each measurement includes a cryptographic hash function generated from the current license 204 stored in the BMC 132. Because the RIM 206 is also a cryptographic hash function of the license 204, a comparison between the two should result in a match if the currently existing license 204 has not been tampered with. If, however, the license 204 is changed in any manner, no match would exist and the console 202 could generate an alert indicating the discrepancy. In one embodiment, one from among multiple blocks of an SPDM message structure may be allocated for fetching the measurement of the license 204. For example, block 10 of the measurements may be allocated for the license measurement.

The console 202 may include any type of IHS 100 that communicates with the BMC 132. For example, the console 202 may be configured to communicate with the BMC 132 monitoring and controlling the operation of the IHS 100. In one embodiment, console 202 includes at least a portion of the Dell EMC OpenManage Enterprise (OME) that is installed on a secure virtual machine (VM), such as a VMWARE Workstation.

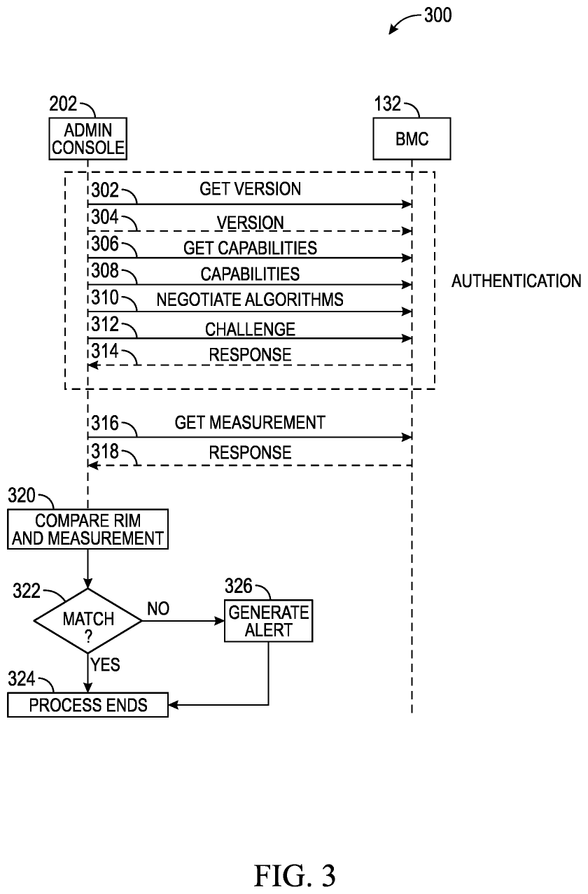

FIG. 3 illustrates an example BMC license file attestation method 300 showing how the BMC license file attestation system may access measurements of the license 204 stored in the BMC 132 to ensure that it is not tampered with according to one embodiment of the present disclosure. Additionally or alternatively, the BMC license file attestation method 300 may be performed, at least in part, by the BMC license file attestation system 200 as described above with reference to FIG. 2. The BMC license file attestation method 300 may be performed at any suitable time. For example, the console 202 may obtain and compare the measurements each time the IHS 100 associated with the BMC 132 is re-booted, each time the BMC 132 is re-booted, and/or at ongoing intervals, such as once each hour, day, or week.

At step 302, the console 202 issues a request for a version of the BMC 132, and at step 304, the BMC 132 responds to the request by sending version information back to the console 202. At step 306, the console 202 issues a request for the capabilities of the BMC 132, and at step 308, the BMC 132 responds to the request by sending its capabilities to the console 202. At step 310, the console 202 communicates with the BMC 132 to negotiate algorithms with the BMC 132. At step 312, the console 202 issues a challenge to the BMC 132, and at step 314, the BMC 132 responds to the challenge by sending a response to the challenge back to the console 202. For example, the console 202 may request and obtain a certificate from the BMC 132, and compare the certificate with its stored version to ensure that the BMC 132 is valid.

At this point, the BMC 132 has been authenticated to the console 202 and the console 202 issues a request for a SPDM-based measurement of the BMC 132 at step 316. In one embodiment, one or more dedicated slots of the SPDM measurement structure may be allocated solely for the measurement of the license 204 stored in the BMC 132. The BMC 132 responds to the request by sending the measurements back to the console 202 at step 318. It should be understood that the measurements may include other cryptographic hash functions of other entities associated with the BMC 132, such the BMC hardware, the BMC firmware, as well as other components in the IHS 100 that the BMC 132 may be associated with.

At step 320, the console 202 obtains the RIM 206 associated with the BMC license 204 and compares it against the measurement obtained from the BMC 132 at step 318. At step 322, If the RIM 206 and the received measurement match, processing continues at step 324 in which the BMC 132 and its associated IHS 100 are allowed to operate in a normal manner with no further action taken. If, however, a match between the RIM 206 and measurement is unsuccessful, processing continues at step 326 in which the console 202 generates an alert message that the license 204 to the BMC 132 has been tampered with. For example, the console 202 may generate a pop-up window on a monitor screen that includes information about the faulty BMC 132 license, such a unique identifier (UID) of the IHS 100 associated with the BMC 132 and the nature of the discrepancy.

The aforedescribed method 300 may be repeatedly performed for ongoing verification of the authenticity of the license 204 stored in the BMC 132. Nevertheless, when use of the BMC license file attestation method 300 is no longer needed or desired, the BMC license file attestation method 300 ends.

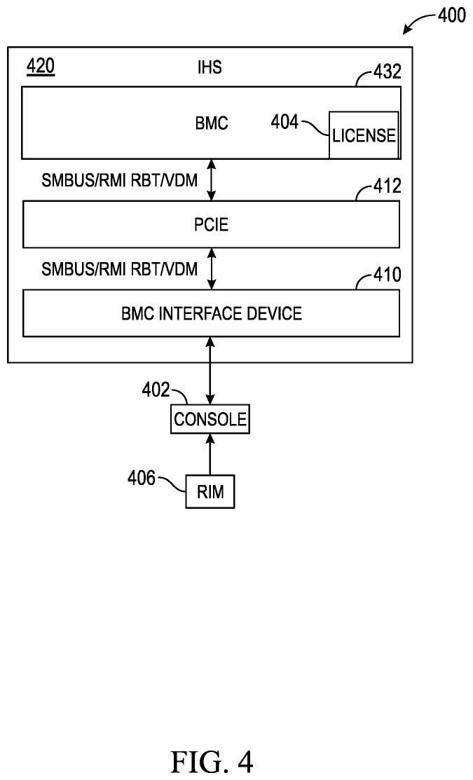

FIG. 4 illustrates an example BMC license file attestation system 400 that may be used to ensure the integrity of BMC licenses according to one embodiment of the present disclosure. The BMC license file attestation system 400 includes an IHS 420, a BMC 432, console 402, a license 404, and a RIM 406 that are similar in design and construction to the IHS 100, BMC 132, console 202, license 204, and RIM 206 as described above with reference to FIG. 2. The BMC license file attestation system 400 is different, however, in that it includes a BMC interface device 410 that allows the console 402 to communicate with the BMC 432 via a PCIe bus 412. Such an arrangement may be useful for alleviating any potential breach of security in which, for example, a custom BMC firmware (e.g., openBMC) is configured with logic that hides or otherwise spoofs the license 404 and any SPDM-based measurements resulting from it.

The BMC interface device 410 may include any type of device that allows the console 402 to communicate with the BMC 432, and can be configured with logic for verifying the authenticity of the license 404 in the BMC 432. Examples of such devices may include a Network Interface Card (NIC) and a Lights Out Management (LOM) device. The BMC interface device 410 may communicate with the console 402 over an Ethernet connection, and with the BMC 432 using the PCIe bus 412. Any type of communication protocol over the PCIe bus 412 may be used, such as a SMBus protocol, a RMI RBT protocol, or a VDM protocol.

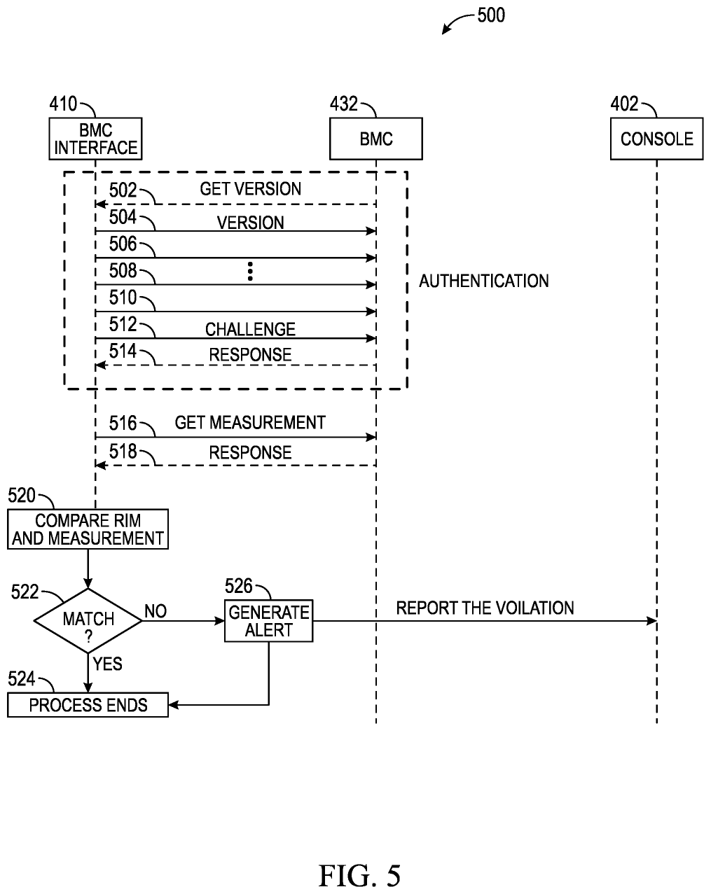

FIG. 5 illustrates an example BMC license file attestation method 500 showing how the BMC license file attestation system 400 of FIG. 4 may access measurements of the license 402 stored in the BMC 432 to ensure its integrity according to one embodiment of the present disclosure.

Initially at step 502, the BMC interface device 410 issues a request for a version of the BMC 432, and at step 504, the BMC 432 responds to the request by sending version information back to the BMC interface device 410. At step 506, the BMC interface device 410 issues a request for the capabilities of the BMC 432, and at step 508, the BMC 432 responds to the request by sending its capabilities to the BMC interface device 410. At step 510, the BMC interface device 410 communicates with the BMC 432 to negotiate algorithms with the BMC 432. At step 512, the BMC interface device 410 issues a challenge to the BMC 432, and at step 514, the BMC 432 responds to the challenge by sending a response to the challenge back to the BMC interface device 410. For example, the BMC interface device 410 may request and obtain a certificate from the BMC 432, and compare the certificate with its stored version to ensure that the BMC 432 is valid.

At this point, the BMC 432 has been authenticated to the BMC interface device 410 and the BMC interface device 410 issues a request for a SPDM-based measurement of the BMC 432 at step 516. The BMC 432 responds to the request by sending the measurements back to the BMC interface device 410 at step 518. At step 520, the BMC interface device 410 obtains the RIM 406 associated with the BMC license 404 and compares it against the measurement obtained from the BMC 432 at step 518. If the RIM 406 and the received measurement match at step 522, processing continues at step 524 in which the BMC 432 and its associated IHS 420 are allowed to operate in a normal manner with no further action taken. If, however, a match between the RIM 406 and measurement is unsuccessful, processing continues at step 526 in which the BMC interface device 410 generates an alert message to the console 402 that the license 404 to the BMC 432 has been tampered with.

The aforedescribed method 500 may be repeatedly performed for ongoing verification of the authenticity of the license 404 stored in the BMC 432. Nevertheless, when use of the BMC license file attestation method 500 is no longer needed or desired, the BMC license file attestation method 500 ends.

Although FIGS. 3 and 5 describe example methods 300 and 500 that may be performed to ensure the integrity of the license 204 and 404, the features of the methods 300 and 500 may be embodied in other specific forms without deviating from the spirit and scope of the present disclosure. For example, either of the methods 300 and 500 may perform additional, fewer, or different operations than those described in the present examples. For another example, either of the methods 300 and 500 may be performed in a sequence of steps different from that described above. As yet another example, certain steps of either of the methods 300 and 500 may be performed by other components in the IHS 420 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a Security Protocol and Data Model (SPDM)-enabled device conforming to a SPDM specification;
a processor; and
a memory coupled to the processor, the memory having program instructions stored thereon that, upon execution, cause the IHS to:
obtain a SPDM-based measurement of a license associated with the SPDM-enabled device;
compare the measurement against a Reference Integrity Measurement (RIM) initially generated for the SPDM-enabled device; and
when the measurement and the RIM do not match, generate an alert message indicating that the license is invalid.

2. The IHS of claim 1, wherein the program instructions are performed by a Baseboard Management Controller (BMC) configured in the IHS.

3. The IHS of claim 1, wherein the program instructions are performed by a BMC interface device configured in the IHS.

4. The IHS of claim 3, wherein the BMC interface device comprises at least one of a Network Interface Card (NIC) or a Lights Out Management (LOM) device.

5. The IHS of claim 3, wherein the BMC interface device is configured to communicate with the BMC using a Peripheral Component Interconnect Express (PCIe) bus.

6. The IHS of claim 1, wherein the program instructions, upon execution, further cause the IHS to obtain the SPDM-based measurement, compare the measurement, and generate an alert message when the measurement and the RIM do not match each time the IHS or a Baseboard Management Controller (BMC) configured in the IHS is re-booted.

7. The IHS of claim 1, wherein the program instructions, upon execution, further cause the IHS to obtain the SPDM-based measurement, compare the measurement, and generate the alert message when the measurement and the RIM do not match at ongoing intervals.

8. The IHS of claim 1, wherein the program instructions, upon execution, further cause the IHS to allocate at least one block of the SPDM-based measurement structure for the measurement.

9. The IHS of claim 1, wherein the program instructions, upon execution, further cause the IHS to generate an alert message comprising a pop-up window indicating a unique identifier (UID) of the IHS associated with the BMC.

10. A Baseboard Management Controller (BMC) license file attestation method comprising:
obtaining a Security Protocol and Data Model (SPDM)-based measurement of a license associated with the SPDM-enabled device conforming to a SPDM specification;
comparing the measurement against a Reference Integrity Measurement (RIM) initially generated for the SPDM-enabled device; and
when the measurement and the RIM do not match, generating an alert message indicating that the license is invalid.

11. The BMC license file attestation method of claim 10, further comprising performing the program instructions by a BMC configured in an Information Handling System (IHS).

12. The BMC license file attestation method of claim 10, further comprising performing the program instructions by a BMC interface device configured in the IHS, wherein the BMC interface device comprises at least one of a Network Interface Card (NIC) or a Lights Out Management (LOM) device, and wherein the BMC interface device is configured to communicate with the BMC using a Peripheral Component Interconnect Express (PCIe) bus.

13. The BMC license file attestation method of claim 10, further comprising obtaining the SPDM-based measurement, comparing the measurement, and generating an alert message when the measurement and the RIM do not match each time the IHS or a Baseboard Management Controller (BMC) configured in the IHS is re-booted.

14. The BMC license file attestation method of claim 10, further comprising obtaining the SPDM-based measurement, comparing the measurement, and generating the alert message when the measurement and the RIM do not match at ongoing intervals.

15. The BMC license file attestation method of claim 10, further comprising allocating at least one block of the SPDM-based measurement structure for the measurement.

16. A computer program product comprising a computer readable storage medium having program instructions stored thereon that, upon execution by an Information Handling System (IHS), cause the IHS to:
obtain a Security Protocol and Data Model (SPDM)-based measurement of a license associated with a SPDM-enabled device conforming to a SPDM specification;
compare the measurement against a Reference Integrity Measurement (RIM) initially generated for the SPDM-enabled device; and
when the measurement and the RIM do not match, generate an alert message indicating that the license is invalid.

17. The computer program product of claim 16, wherein the program instructions are performed by a Baseboard Management Controller (BMC) configured in the IHS.

18. The computer program product of claim 16, wherein the program instructions are performed by a BMC interface device configured in the IHS, wherein the BMC interface device comprises at least one of a Network Interface Card (NIC) or a Lights Out Management (LOM) device, and wherein the BMC interface device is configured to communicate with the BMC using a Peripheral Component Interconnect Express (PCIe) bus.

19. The computer program product of claim 16, wherein the program instructions, upon execution, further cause the IHS to obtain the SPDM-based measurement, compare the measurement, and generate the alert message when the measurement and the RIM do not match each time the IHS or a Baseboard Management Controller (BMC) configured in the IHS is re-booted.

20. The computer program product of claim 16, wherein the program instructions, upon execution, further cause the IHS to obtain the SPDM-based measurement, compare the measurement, and generate the alert message when the measurement and the RIM do not match at ongoing intervals.
